(19) United States
(12) Patent Application Publication
(10) Pub. No.: US 2007/0077920 A1
(43) Pub. Date: Apr. 5, 2007

(54) Methods, systems and computer program products for aggregating communications and media data

(76) Inventors: Phillip Weeks, Atlanta, GA (US); Gregory Newton, Dunwoody, GA (US); John Ruckart, Atlanta, GA (US)

Correspondence Address: MYERS BIGEL SIBLEY & SAJOVEC, P.A., P.O. BOX 37428, RALEIGH, NC, 27627, US

(21) Appl. No.: 11/410,624

(22) Filed: Apr. 25, 2006

Related U.S. Application Data
(60) Provisional application No. 60/717,223, filed on Sep. 15, 2005.

(51) Int. Cl. H04Q 7/38

(52) U.S. Cl. 455/414.1

(57) ABSTRACT

Computer implemented methods of coordinated control of a plurality of different services for a user include associating data records from each of the different services to provide an aggregated database. The different services include a communications service of the user, a media service of the user and a calendar of the user. A user interface is provided to a user for establishing settings of at least one of the data records in the aggregated database to control the different services. An interaction model associated with the different services is also provided. A current state of at least one of the data records in the database that is specified in the interaction model is detected. Operation of at least one of the different services is automatically controlled based on the detected current state and the interaction model.

### CROSS REFERENCE TO RELATED APPLICATION

This Application is related to and claims the priority of U.S. Provisional Patent Application Ser. No. 60/717,223, filed Sep. 15, 2005, entitled Systems and Methods for Aggregating Communications and Media Data, the disclosure of which is hereby incorporated herein by reference.

### BACKGROUND

The present invention generally relates to the field of communications services and, more particularly, to user interfaces for communications services.

A wide variety of communications services are available for users. For example, a single user may have a home phone, work phone, and mobile phone. In addition, the user may also use devices such as PC's, PDA's, and pagers for data communications, such as email and instant messaging.

As communications services develop they offer more functionality and options. As a result, they are becoming more complex to use and manage. For example, a person could use a home phone, cellphone, work phone, email, work email and the like as communications services. In additions, a number of phones and computers could be included in a home or office, thereby providing access to those communications services from different locations in the home or office. Different addresses or identifications could be associated with each of these phones and/or computers or other user input/output devices that may be used in connection with the communication services.

Communications are becoming even more ubiquitous in peoples' lives and their environment with the increasing availability of set top boxes and personal video recorders (PVRs) and the like providing even more communication and entertainment functionality in a “digital home.” As with the different communications services discussed above, these entertainment services and devices also are typically controlled separately through separate interfaces. For instance, a user's communications service profile, device availability, set top box, calendar and PVR are all typically controlled separately and do not interact.

Each of the services and/or devices will typically have its own associated set of features and settings. Managing all these options may be so complicated and annoying for a user, that users may forego taking full advantage of all the features available to them. As such, they may perceive the provided services as less valuable and less desirable. They may also fail to add new premium services associated with the services because of a perceived inability to take advantage of those features. Therefore, the ability to market communications services may be adversely affected.

### SUMMARY

In some embodiments, computer implemented methods of coordinated control of a plurality of different services for a user include associating data records from each of the different services to provide an aggregated database. The different services include a communications service of the user, a media service of the user and a calendar of the user. A user interface is provided to a user for establishing settings of at least one of the data records in the aggregated database to control the different services. An interaction model associated with the different services is also provided. A current state of at least one of the data records in the database that is specified in the interaction model is detected. Operation of at least one of the different services is automatically controlled based on the detected current state and the interaction model.

In other embodiments, automatically controlling includes automatically controlling operation of one of the communications service of the user, the media service of the user and the calendar of the user responsive to detecting the current state of at least one of the data records from another of the communications service of the user, the media service of the user and the calendar of the user. The communications service may be wireline phone service and/or cellular phone service and the data records from the communications service may include settings for a plurality of features associated with the communications services. The features may include call blocking, call filtering, call forwarding, voicemail and/or email notification. Associating data records may include accessing a profile database of the communications service, a media service database of the user and a calendar database of the user through a common interface module.

In further embodiments, the data records from the communications service include a plurality of user selectable profiles defining different settings for ones of the features and a designation of one of the profiles as the current settings of the communications service and the media service includes a personal video recorder. Detecting a current state includes detecting playing of a video by the personal video recorder as a current state of the media service and automatically controlling includes automatically controlling operation of the communications service by designating a different one of the user selectable profiles as the current settings of the communications service based on the detected current state and the interaction model. Detecting a current state may include identifying the one of the profiles that is designated as the current settings of the communication service and automatically controlling may include automatically controlling a recording schedule for the personal video recorder based on the identified one of the profiles and the interaction model.

In yet other embodiments, detecting a current state includes detecting a request for delivery at a future time of a video content by the media service. Automatically controlling includes automatically updating a data record of the calendar to indicate delivery of the video content at the future time in the calendar of the user. Automatically controlling may further include automatically controlling operation of the communications service by designating a different one of the user selectable profiles as the current settings of the communications service at the future time based on the request for delivery at the future time of the video content and the interaction model. Designating a different one of the user selectable profiles as the current settings of the communications service may be carried out at the future time. Detecting a request for delivery at the future time may include detecting a duration of the video content and a different one of the user selectable profiles may be designated as the current settings of the communications service starting at the future time and for the detected duration of the video content. The designation of the current settings may then be reset to reverse the designation of the different one of the user selectable profiles as the current settings. Updating a data record of the calendar to indicate delivery of the video content at the future time in the calendar of the user may include automatically updating a data record of the calendar to indicate the duration of the delivery of the video content at the future time in the calendar of the user.

In further embodiments, detecting a current state includes detecting a scheduled event from the calendar of the user and automatically controlling further includes automatically controlling operation of the communications service by designating a different one of the user selectable profiles as the current settings of the communications service and/or automatically controlling a recording schedule for a personal video recorder included in the media service based on the identified one of the profiles and the interaction model.

In yet further embodiments, automatically controlling operation includes communicating instructions to at least one device associated with the at least one of the different services using an Internet Protocol (IP) format. The at least one device may be a Voice over Internet Protocol (VoIP) telephone, a personal video recorder (PVR) and/or a home media hub.

In other embodiments, computer systems for coordinated control of a plurality of different services for a user include an aggregated database that associates data records from each of the different services. The different services include a communications service of the user, a media service of the user and a calendar of the user. An interaction model associated with the different services defines actions to control operations of ones of the different services based on a current state of the different services. A service management module is configured to provide a user interface to a user for establishing settings of at least one of the data records in the aggregated database to control the different services, detect a current state of at least one of the data records in the database that is specified in the interaction model and to automatically control operation of at least one of the different services based on the detected current state and the interaction model.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE FIGURES

FIG. 1 is a block diagram of a data processing system suitable for use in some embodiments of the present invention.

FIGS. 2-5 are flowcharts illustrating operations for setting communications service features for a user according to some embodiments of the present invention.

FIGS. 6-13 are schematic diagrams illustrating user interface screens and the use of the same in setting communication service features for a user according to some embodiments of the present invention.

FIG. 14 is a block diagram of a data processing system suitable for use in some embodiments of the present invention.

FIGS. 15-17 are flowcharts illustrating operations for coordinated control of a plurality of different services for a user according to some embodiments of the present invention.

FIGS. 18 is a schematic diagram illustrating user interface screens and the use of the same in coordinated control of a plurality of different services for a user for a user according to some embodiments of the present invention.

### DETAILED DESCRIPTION OF EMBODIMENTS OF THE INVENTION

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, when an element is referred to as being “coupled” to another element, it can be directly coupled to the other element or intervening elements may be present. In contrast, when an element is referred to as being “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described below with reference to block diagrams and/or flowchart illustrations of methods, apparatus, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

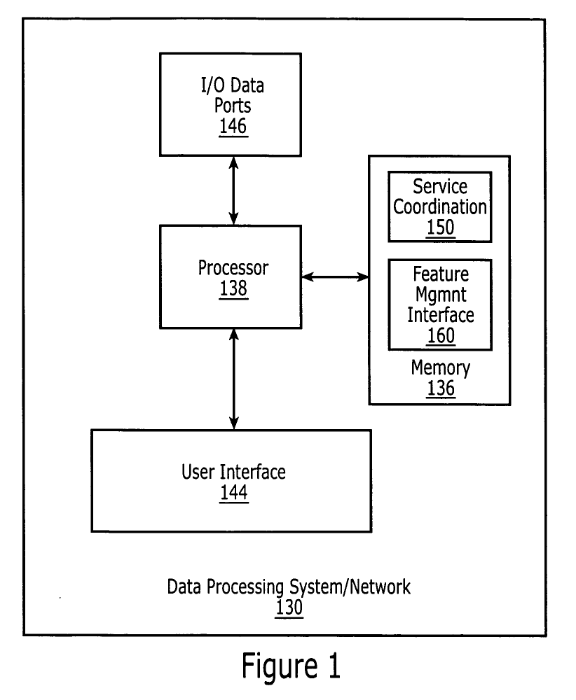

Referring now to FIG. 1, an exemplary embodiment of devices, for example, an application server (AS) or the like or other data processing system 130 configured in accordance with some embodiments of the present invention will be discussed. The data processing system 130, which may be incorporated in, for example, a personal computer, a PDA, a wireless terminal/phone, or the like, may include a user interface 144, including, for example, input device(s) such as a keyboard or keypad, a display, a speaker and/or microphone, and a memory 136 that communicate with a processor 138. The data processing system 130 may further include an I/O data port(s) 146 that also communicates with the processor 138. The I/O data ports 146 can be used to transfer information between the data processing system 130 and another computer system or a network that may be associated with a communications service provider or user communication devices using, for example, an Internet Protocol (IP) connection. These components may be conventional components such as those used in many conventional data processing systems, which may be configured to operate as described herein.

As shown in the embodiments of FIG. 1, the memory 136 includes a service coordination module 150 and a feature management interface module 160. The service coordination module 150 and/or feature management interface module 160 may be implemented, for example as part of the operating system, as application programs, as components of a dynamic link library or the like of the data processing system 130 so as to be executed by the processor 138.

The service coordination module 150 may be configured to identify a plurality of communications services of the user. The plurality of communications services may include wire line phone service, cellular phone service and/or electronic mail (e-mail) service. It will be understood that, as used herein, electronic mail or e-mail refers to text based communications services and may include text based services such as multimedia message service (MMS) and/or short message service (SMS) or like services that may be provided, for example by a cellular phone service provider, as well as IP address based e-mail. The feature management interface module 160 may be configured to define user selectable communications service scenarios for the user. The feature management interface module 160 may further be configured to establish settings for the plurality of communications services to be applied for the user upon selection of one of a plurality of communications service scenarios for the user and to receive a selection of one of the scenarios. The service coordination module 150 may be configured to automatically change current settings of the communications service features for the user to the established settings responsive to receiving the selection of one of the scenarios.

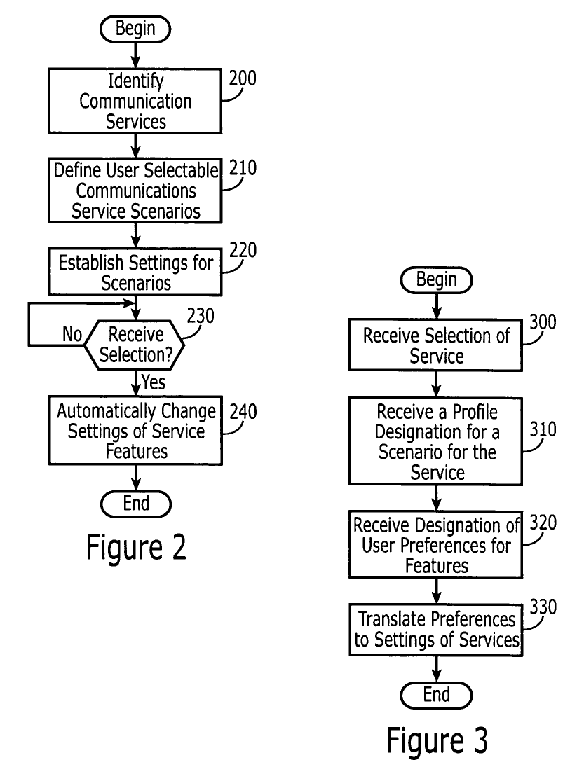

A computer implemented method of establishing settings of communications service features for a user according to some embodiments of the invention will now be described with reference to the flow chart illustration of FIG. 2. As shown for the embodiments of FIG. 2, operations begin by identifying a plurality of communications services of the user (block 200). The plurality of communications services includes wire line phone service, cellular phone service and/or electronic mail (e-mail) service. A plurality of each type of such communications service may be provided where, for example, different telephone numbers or Internet protocol (IP) addresses are associated with different ones of the services.

A plurality of user selectable communications service scenarios are defined for the user (block 210). Such scenarios may include, for example, do not disturb, vacation, eating, or the like. In some embodiments, one of the scenarios is a default scenario having an associated default profile. The default scenario may correspond to an initial state of the features of a communications service when first acquired by the user and/or may be defined by a user as the settings of features to be used when no other scenario has been selected by the user.

Settings for the plurality of communications services that are to be applied for the user upon selection of respective ones of the scenarios are established (block 220). A selection of one of the scenarios is received (block 230). When a selection has been received, the current settings of the communications service features for the user are automatically changed to the established settings for the selected one of the scenarios responsive to receiving the selection of one of the scenarios (block 240).

Operations for establishing settings at block 220 according to some embodiments of the present invention will now be further described with reference to the flowchart illustration of FIG. 3. As shown in the embodiments of FIG. 3, a selection of one of a plurality of communications services is received (block 300). A designation of a profile to be associated with the selected one of the plurality of communications services to identify the user selectable communications service scenario is received (block 310). For example, a user establishing settings of the features of various communications services for when they are on vacation may designate a scenario as “vacation” at block 310.

A designation of user preferences for communications service features to be associated with a designated profile is received (block 320). The user preferences for the communications service features are translated to communication system settings affecting the plurality of communications services of the user to establish the settings for the plurality of communications services to be applied for the user upon selection of the scenario (block 330). Operations at blocks 300-330 may be repeated to create and define additional settings for different scenarios. For example, a user leaving on vacation may wish to create a profile that will cause incoming phone calls to a home wire line telephone number to be forwarded to the user's wireless cellular phone service rather than ringing through to phones of the home wire line service. The service provider supporting the wire line telephone service may then be provided the user's preference regarding such call forwarding and the destination number for call forwarding and may implement the request with the appropriate settings in the call routing protocol of the service provider to implement the desired call handling in the selected scenario for the user.

As noted above, ones of the communications services of the user may be associated with a telephone number, Internet address or the like. Accordingly, operations at block 300 may include receiving a selection of a telephone number of a communications service of the user. A user may have a plurality of telephone numbers associated with their communications services and receiving the selection may include displaying a list of the user's telephone numbers when receiving a selection of one of the displayed telephone numbers at block 300. Similarly, a designation of a profile may be received at block 310 by displaying a list of available profiles associated with the selected one of the displayed telephone numbers and receiving a selection of one of the listed items. The list of available profiles may also include an edit profile and/or a new profile creation option allowing editing of a selected one of the profiles to be used for the telephone number or creation of a new name profile to be associated with the telephone number for that communications service of the user. It will be understood that, while an example regarding call forwarding was used with reference to operations at block 330 above, the communications service may have a plurality of different features for which settings may be established, such as call blocking, call filtering, call forwarding, voicemail and/or e-mail notification.

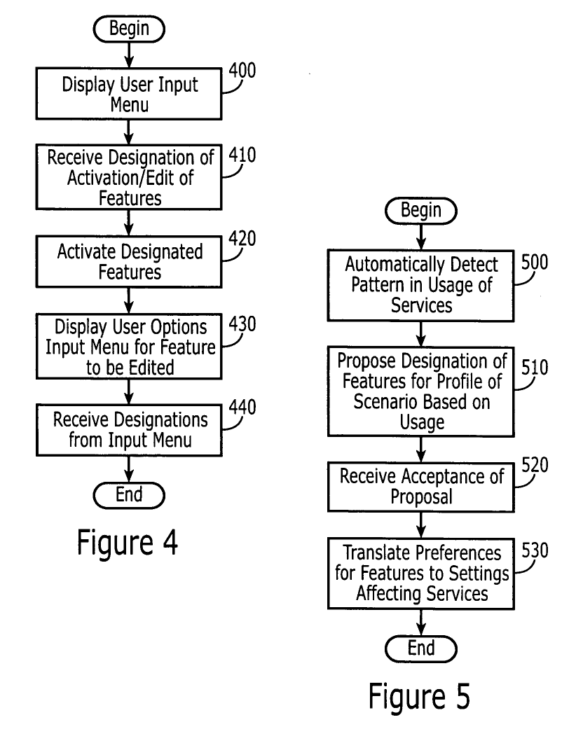

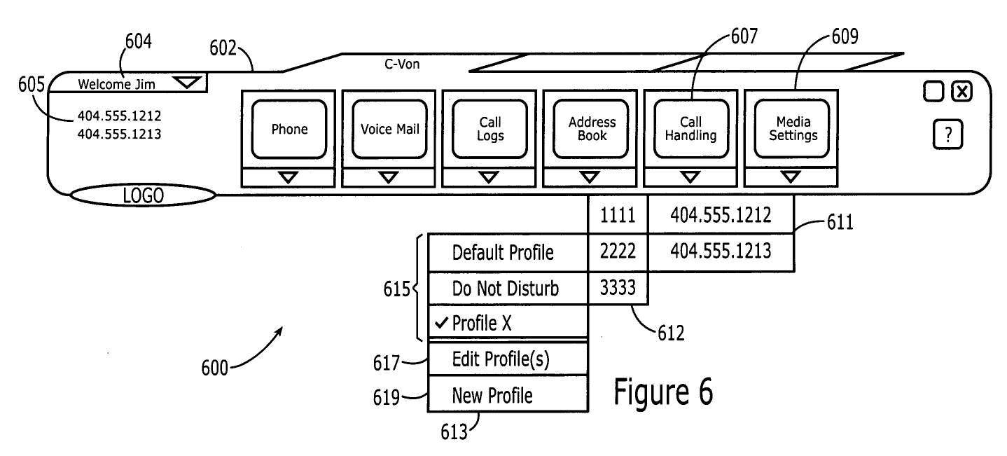

Operations for receiving a designation of user preferences for communications service features at block 320 according to some embodiments of the present invention will now be further described with reference to the flowchart illustration of FIG. 4. A user input menu is displayed including an identification of available features along with a narrative description of current settings associated with a designated profile (block 400). An example of such an input menu will be further described with reference to FIG. 6. A designation of activation of a selected one of the available features and/or a designation of one of the available features to be edited is received (block 410). When a designation of activation of one of the available features is received, the selected one of the available features is activated (block 420). When a designation of an available feature to be edited is received, a user input menu is displayed including user options associated with the designated feature (block 430). A designation of a user option is received responsive to display of the user input menu including the user options (block 440).

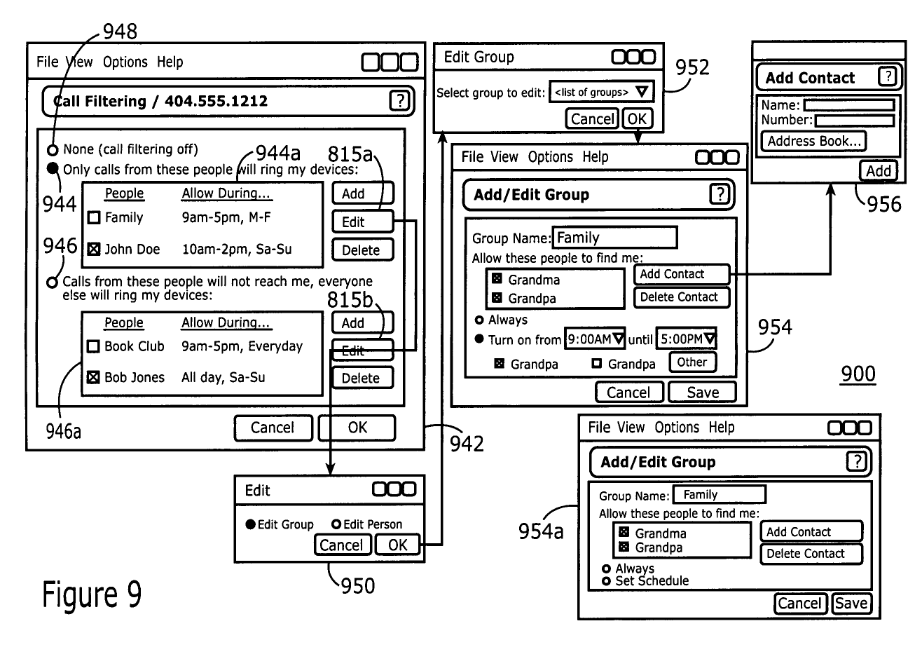

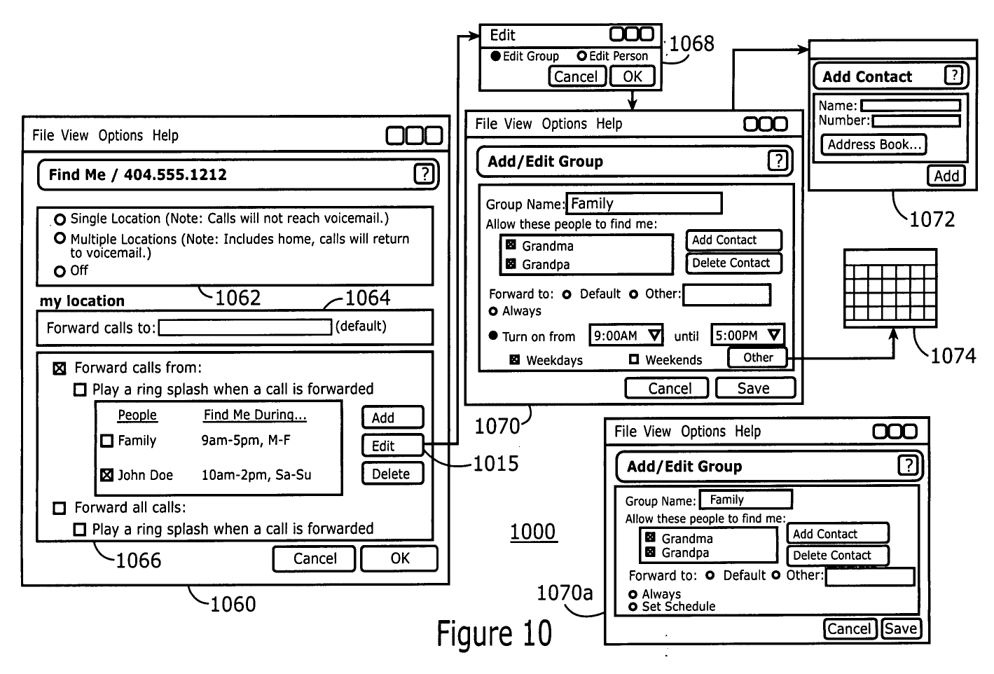

In some embodiments of the present invention where the selected one of the features is call filtering, the user option displayed at block 430 may include designation of callers that will be announced to the user, designation of callers that will not be announced to the user, and/or designations of callers to be associated with a group (see, e.g., FIG. 9). The group may be designated as a caller to be announced to the user and/or a caller that will not be announced to a user. In some embodiments where the selected feature is call forwarding, the user option displayed at block 430 may include a designation of callers that will be forwarded to an alternative phone number and/or a designation of the alternative phone number (see, e.g., FIG. 10). Designation of a ring tone to generate for forwarded calls and/or a designation of callers to be associated with a group, wherein the group may be designated as a caller to be forwarded to the alternative phone number may also be displayed options. The alternative phone number in some embodiments is a plurality of alternative phone numbers. In further embodiments, the alternative phone number is a plurality of voice over Internet protocol (VoIP) devices mapped to a same phone number.

In other embodiments where the selected feature is e-mail notification, the user options displayed at block 430 may include designation of an e-mail address for e-mail notification, designations of callers that will trigger an e-mail notification and/or designation of callers to be associated with a group, wherein a group may be designated as a caller that will trigger an e-mail notification (see, e.g., FIG. 1A). The e-mail notification may be generated responsive to receipt of a call from a designated caller and/or responsive to receipt of a voicemail.

Operations for defining a plurality of user selectable communications service scenarios at block 210 and establishing settings at block 220 according to some embodiments of the present invention will now be further described with reference to the flowchart illustration of FIG. 5. As seen in the embodiments of FIG. 5, a user's usage of the plurality of communications services of the user corresponding to one of the communications service scenarios for the user may be automatically detected (block 500). A designation of user preferences for communications service features to be associated with a profile that is in turn associated with the scenario may be proposed based on the detected pattern (block 510). An acceptance of the proposed designation of user preferences may be received (block 520). However, it will be understood that prompting a user to accept a proposal may not be required in some embodiments of the present invention. The proposed designation of user preferences for the communications service features may be translated to communication system settings affecting a plurality of communications services of the user to establish the settings for the plurality of communications services to be applied for the user upon selection of the one of the scenarios (block 530). Thus, as described with reference to the embodiments of FIG. 5, user usage patterns of various communications services may be monitored to detect patterns that may indicate that a new scenario should be proposed to a user for future use. In addition, modifications to the user preferences for features to be applied for an already defined scenario may be proposed based on the user's actual experience during periods where the profile has been selected by the user.

User interface screens and operations associated with the use of the same in setting communications service features for a user according to some embodiments of the present invention will now be further described with reference to the schematic diagram illustrations of FIGS. 6-13. As shown in FIG. 6, a user setting main menu screen 600 may be provided including a service designation field 602 including a user greeting field 604 displaying a personalized greeting for a user and a communications services identifier field 605, shown in FIG. 6 as listing two telephone numbers associated with voice communications services of the user. A plurality of different selection fields may be provided shown as Phone, Voicemail, Call Logs, Address Books, Call Handling and Media Settings in FIG. 6. Only the Call Handling field 607 and the Media Settings field 609 will be further discussed herein. It will be further understood that the service designations field 602 may include screen selection tabs and different user input selection options may be provided responsive to a user moving a cursor or the like over an alternative tab and selecting different services.

As shown in the illustrative example of FIG. 6, when a user selects the Call Handling field 607, identification numbers associated with different communications services available for the user are displayed, here shown as phone numbers 611. When a user places a cursor over or selects one of the phone numbers 611, a plurality of different extensions 612 associated with the selected number 611 are illustrated as being displayed in a pull down box. For example, a family telephone line may have multiple associated extensions and each extension may be provided its own profile or profiles. As illustrated in the example of FIG. 6, three extensions 612 are shown and, when a user places a cursor over or selects one of the extensions 612, a pull down box 613 may be displayed listing available profiles and profile options. As shown in the illustrative embodiments of FIG. 6, the selected extension 612 has three named profiles 615, the current selected one of which, “Profile X,” is shown as active by a checkmark next to the name of the active profile. The pull down box 613 shown in FIG. 6 further includes an Edit profile field 617 and New profile field 619. Thus, a change to an already defined profile may be instituted by a user selecting a different one of the available profiles 615. Furthermore, one of these existing profiles may be edited by selecting the Edit Profile field 617 or a new profile may be created by selecting the New Profile field 619.

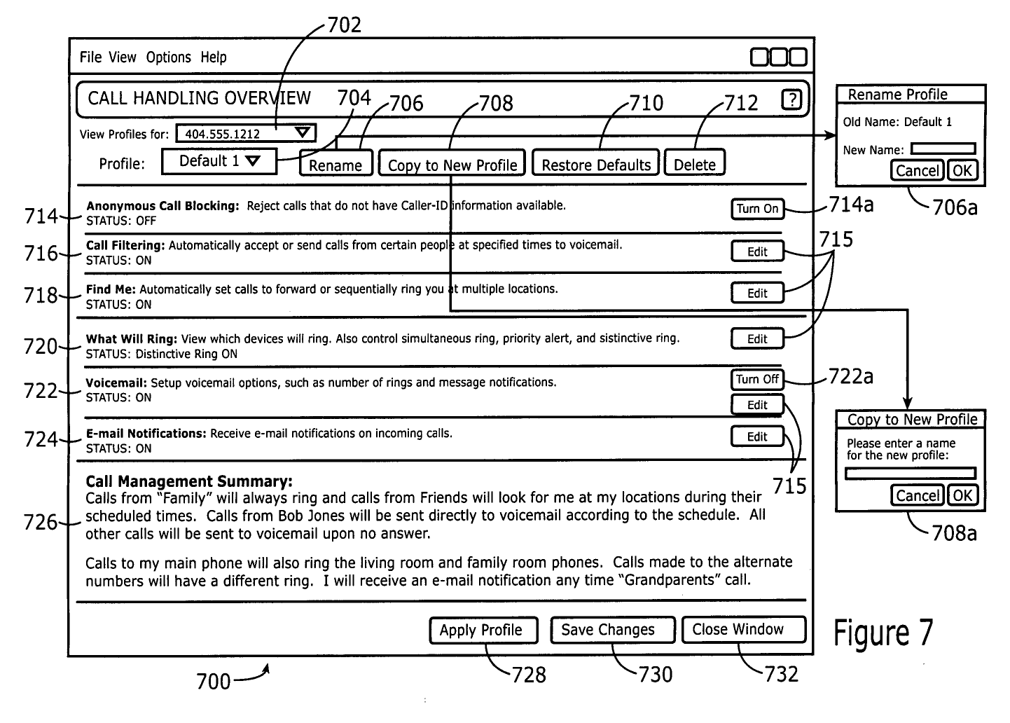

As shown in the schematic diagram of FIG. 7, upon selection of a profile for a communications service of a user, a Call Handling Overview 700 may be displayed. For example, as shown in the communications service Identification Number field 702 and the Profile Name field 704, FIG. 7 illustrates a Call Handling Overview 700 for telephone number 404.555.1212 for associated profile Default 1. User features selectable from the Call Handling Overview 700 include the Rename field 706, selection of which may lead to display of the Rename Profile display 706a allowing for entry and acceptance of a new name for the profile. Selection of the Copy to New Profile field 708 may lead to display of a Copy to New Profile screen 708a, allowing entry of a new name for a new profile. In other words, creation of a new profile may start by initially populating the settings for the various features with the settings already created for an existing profile rather than simply using default settings or leaving the settings in an indeterminate state pending user input.

Where a default profile is defined for the user, the Restore Default field 710 may be selected to automatically restore the settings of the currently displayed profile to the default settings. Finally, the Delete field 712 may be selected to delete the displayed profile.

With respect to the user input menu portions of the Call Handling Overview 700 specific to available user options associated with the selected telephone number, fields 714 through 724 are associated with different available features for the selected communications service associated with the selected telephone number and profile. The displayed feature user option input fields shown in FIG. 7 include a Call Blocking field 714, a Call Filtering field 716, a Find Me field 718, a What Will Ring field 720, a Voicemail field 722 and an E-mail Notification field 724.

In addition, for some embodiments of the present invention as shown in the Call Handling Overview 700, a plain text representation of the affect of the currently selected settings from the perspective of the user is generated and displayed in the Call Management Summary field 726. Providing the summary in the Call Management Summary field 726 may make it simpler for a user to understand the affect of the settings as selected by the user so they will be less likely to pick settings that fail to deliver the performance that was desired by the user. The summary provided in the Call Management Summary field 726 may also be beneficial for a user as various details of the effective settings, which would otherwise only be available by stepping through and viewing various different displays accessible through the Call Handling Overview 700, may be readily presented on a single screen without the need for further user knowledge of which different display selection fields need to be utilized or the need for the user to walk through multiple such interactions to obtain a desired summary of the settings of the currently selected profile. As a result, the simplicity of the user selection process for a user may be enhanced over time as profiles are established for different scenarios as a user may not need to remember all the details of each previously created profile as selection of the profile may generate a brief summary providing the user the information needed to determine an appropriate profile to select at any given point in time. The displayed summary may also facilitate a user identifying particular details that the user would like to change on the profile and which of the user option input fields to select to change the desired feature.

As shown in the embodiments of FIG. 7, the user option input fields 714-724 may vary in the available selection options for a user. For example, the Call Blocking field 714 is shown with a Turn-On (Off) field 714a so that Call Blocking can be turned on or off without a need to select and bring up a subsequent display. Similarly, the Voicemail field 722 includes a Turn-Off (On) field 722a. However, the Voicemail field 722, like the Call Filtering field 716, the Find Me field 718, the What Will Ring field 720 and the E-mail Notifications field 724 include an Edit field 715 that may be selected to bring up a subsequent display for user input and editing to change and/or establish features for the selected profile identified in field 704. Finally, an Apply Profile field 728, Save Changes field 730 and Close Window field 732 are shown in the Call Handling Overview 700 of FIG. 7, which may be selected to initiate operations corresponding to the descriptions of the respective fields.

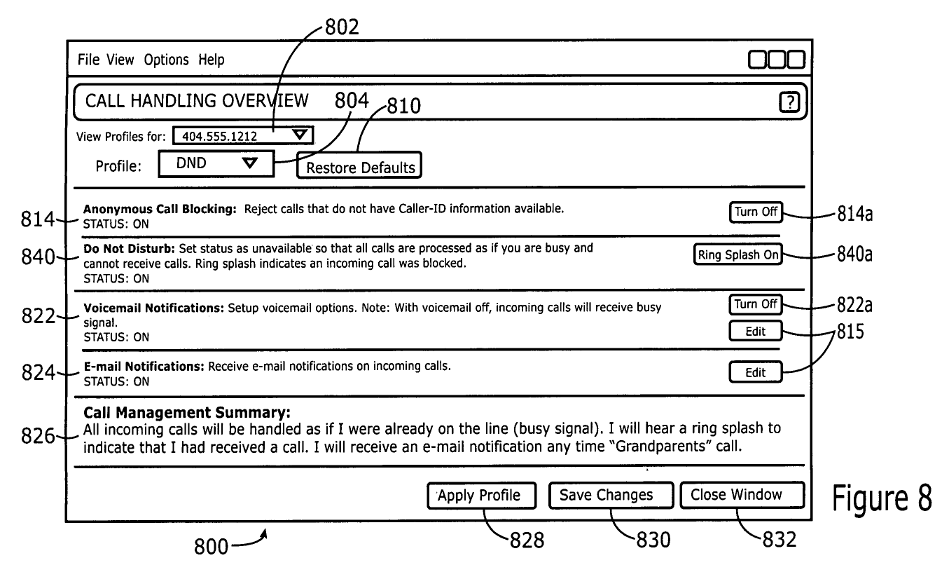

FIG. 8 is a schematic diagram illustrating another Call Handling Overview 800 associated with a communications service (404.555.1212) listed in an Identification Number field 802 and a profile (Do Not Disturb (DND)) for that communications service listed in a Profile Name field 804. The Call Handling Overview 800 differs in that, while a Restore Default field 810 is provided, Rename, Copy to New Profile and Delete are not shown as fields in the Call Handling Overview 800. In addition, available user option fields include a Call Blocking field 814, a Do Not Disturb field 840, a Voicemail Notifications field 822, and an E-mail Notifications field 824, ones of which have associated Turn-Off (On) fields 814a, 822a and/or Edit fields 815. As with the embodiments of FIG. 7, a Call Management Summary field 826 is provided as well as an Apply Profile field 828, Save Changes field 830, and a Close Window field 832. In addition, the Do Not Disturb field 840 is shown as having a Ring Splash On (Off) field 840a for requesting a ring splash indicating an incoming call was blocked when the ring splash is turned on.

An example of user interface screens generated responsive to user selection of the Edit field 715 in the Call Filtering field 716 will now be described with reference to the schematic illustration of FIG. 9. As shown in the embodiments illustrated in FIG. 9, when the Edit field 715 in the Call Filtering field 716 of FIG. 7 is selected, a Call Filtering display 942 is generated. The field 944 designating people whose incoming calls will ring to user's devices is selected is activated as shown in FIG. 9, which provides a display field 944a allowing selections of individual users or groups of users. In addition, Add and Delete fields as well as an Edit field 815 are available for user selection. Other options for selection in the user display 942 include a field 946 for specifying people whose calls will not reach the user and a field 948 for turning off call filtering.

When the Edit field 815a is selected for designating people to ring through, the user display 950 is generated to allow selection of Edit Group or Edit Individual. When Edit Group is selected, a user display 952 is shown allowing selection of the group to edit. After selection from the pull down menu of the group “Family,” the user display 954 is generated allowing user editing of configuration information for the group “Family.” As shown in user display 954, two persons, Grandma and Grandpa are included under the “Family” group name of the user at call number 404.555.1212 for weekdays between 9:00 a.m. and 5:00 p.m. User display 954a is a display where the “always find” selection is shown rather than a scheduled window limiting when call forwarding will find a user from the designated members of the group “Family.” Also shown in FIG. 9, is a user display 956 that may be generated responsive to an Add Contact selection from the user interface 954 to add an additional person to the group “Family.”

FIG. 10 is a schematic diagram illustrating various user interface option displays that may be generated responsive to selection of the Edit field 715 in the Find Me field 718 of the interface of FIG. 7. As shown in the embodiments of FIG. 10, selection of the Edit field generates the user display 1060. As shown in the input field 1062, single, multiple or no location may be generated for the Find Me function. At field 1064, a number or numbers may be provided for call forwarding associated with the Find Me function. In field 1066, options related to what calls to forward from particular users or all users are presented with John Doe shown as being enabled for the Find Me function between 10:00 a.m. and 2:00 p.m. on Saturdays and Sundays. A ring splash on call forwarding option is also shown. In addition to an Add and Delete field for field 1066, an Edit field 1015 may be selected, which may generate the Edit Group/Person user display 1068. When Edit Group is selected in the user display 1068, a user display 1070 may be generated showing options related to editing for a group “Family.” The individuals to include in the Find Me function and the times to allow the Find Me function to operate for calls from those individuals are shown along with various selection options in the user display 1070. Similarly to the discussion of FIG. 9, the user display 1070a corresponds to the user display 1070 except for the selection of Always rather than set schedule on application of the Find Me function to the specified group members.

When Add Contact is selected from the user interface 1070, an Add Contact user display 1072 may be generated. Furthermore, also shown in FIG. 10 is a graphical calendar pop up window 1074 that may be used to facilitate entry of a specified time and day to allow the Find Me function to provide forwarding.

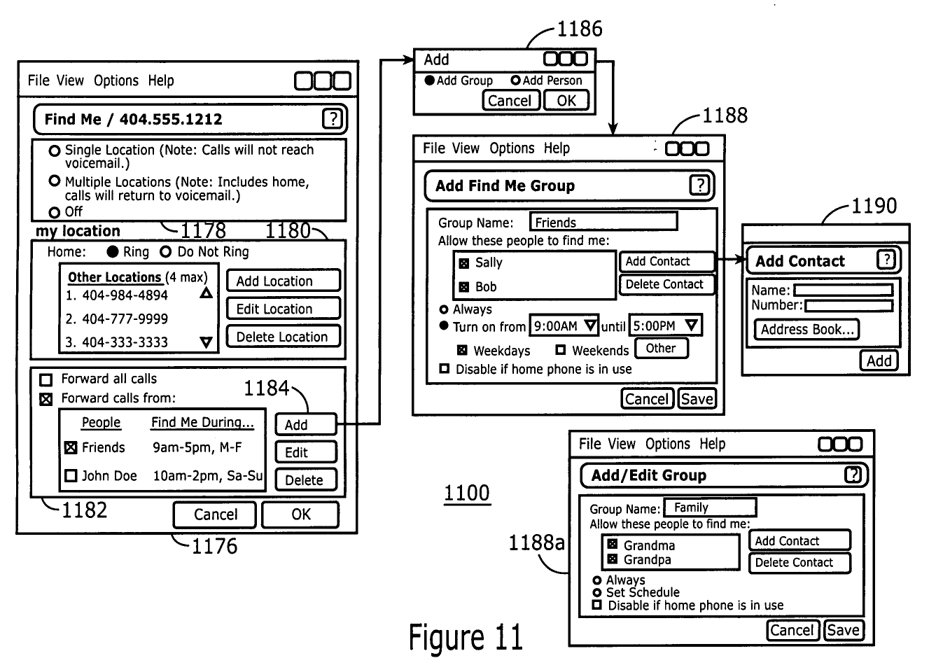

FIG. 11 is a schematic diagram showing user interfaces for an alternative configuration of the Find Me edit function as discussed previously with reference to FIG. 10. FIG. 11 differs from FIG. 10 in that the initial user display 1176 includes the selection of multiple locations in the field 1178. The other locations may be specified in the field 1180, while a designation of individuals to be provided to Find Me forwarding may be provided in field 1182.

Also shown in FIG. 11 is a sequence of displays associated with selection by a user of an Add field 1184 calling up an Add Group/Person user display 1186. Selection of the OK field in the user interface 1186 when Add Group is selected may provide a user display 1188, shown as allowing user configuration of a group name “Friends.” The user display 1188a corresponds to the user display 1188 except with the Always rather than Set Schedule specification for the group being edited. When Add Contact is selected from the user display 1188, an Add Contact user display 1190 may be generated to add additional members to the group “Friends.”

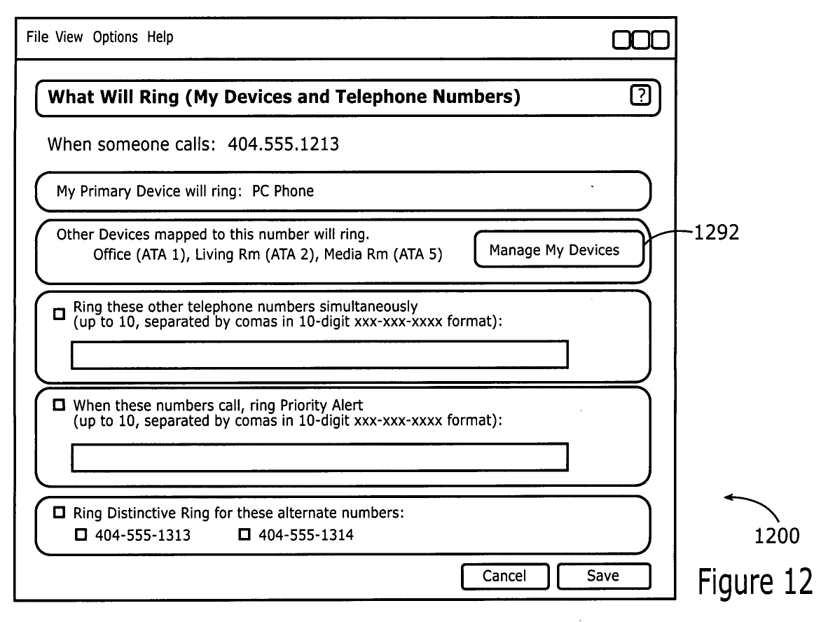

FIG. 12 illustrates an exemplary user display 1200 that may be generated responsive to selection of the Edit field 715 in the Will Ring field 720 of the user interface 700 of FIG. 7. As seen in the user display 1200, user configuration options are provided for actions to be taken when someone calls a number 404.555.1213. In addition to designating a primary device to ring, other telephone numbers to ring, a priority alert option and distinctive ring for particular alternate numbers, an Other Device Mapping field is shown in the embodiments of FIG. 12. When the Manage My Devices field 1292 is selected, a list of available devices that may be configured and linked to the communications service mapping may be generated for user selection. The list of devices may correspond to a list of devices generated by selection of the Media Settings field 609 of FIG. 6. As shown in FIG. 12, the number 404.555.1213 is currently mapped to a primary PC phone and three additional Voice over IP (VoIP) extensions ATA1, ATA2 and ATA5.

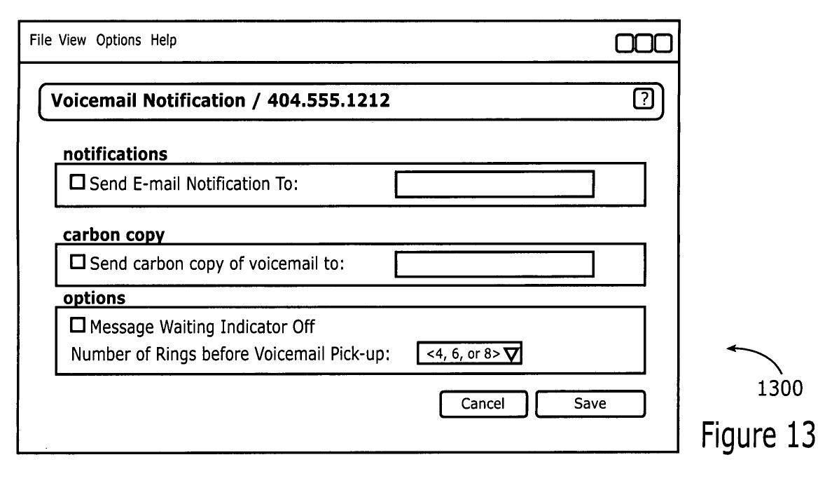

FIG. 13 is a schematic diagram illustrating a user interface 1300 that may be generated responsive to selection of the Edit field 715 in the Voicemail field 722 of FIG. 7. As shown in FIG. 13, various options for voicemail notifications when a voicemail has been received are presented to a user through the user display 1300.

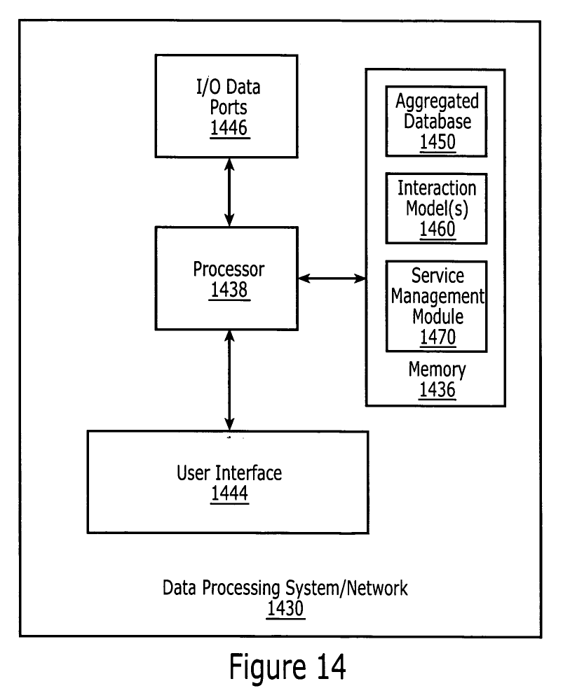

Referring now to FIG. 14, an exemplary embodiment of devices, for example, an application server (AS) or the like or other data processing system 1430 configured in accordance with some embodiments of the present invention will be discussed. The data processing system 1430, which may be incorporated in, for example, a personal computer, a PDA, a wireless terminal/phone, or the like, may include a user interface 1444, including, for example, input device(s) such as a keyboard or keypad, a display, a speaker and/or microphone, and a memory 1436 that communicate with a processor 1438. The data processing system 1430 may further include an I/0 data port(s) 1446 that also communicates with the processor 1438. The I/0 data ports 1446 can be used to transfer information between the data processing system 1430 and another computer system or a network that may be associated with a communications service provider, media provider or user communication and/or media devices using, for example, an Internet Protocol (IP) connection. These components may be conventional components such as those used in many conventional data processing systems, which may be configured to operate as described herein.

As shown in FIG. 14, the memory 1436 includes an aggregated database 1450 that associates data records from each of a plurality of different services. The different services include a communications service of the user, a media service of the user, and a calendar of the user. The memory 1436 also is shown as including an interaction model 1460 associated with the different services. The interaction model 1460 defines actions to control operations of ones of the different services based on a current state of the different services. The memory 1436 is also shown as including a service management module 1470. The service management module 1470 is configured to provide a user interface to a user for establishing settings of at least one of the data records in the aggregated database 1450 to control the different services, to detect a current state of at least one of the data records in the database 1450 that is specified in the interaction model 1460 and to automatically control operation of one or more of the different services based on the detected current state and the interaction model 1460. The aggregated database 1450, the interaction model 1460 and/or the service management module 1470 may be implemented, for example, as part of the operating system, as application programs, as components of a dynamic library or the like of the data processing system 1430 so as to be executed by the processor 1438.

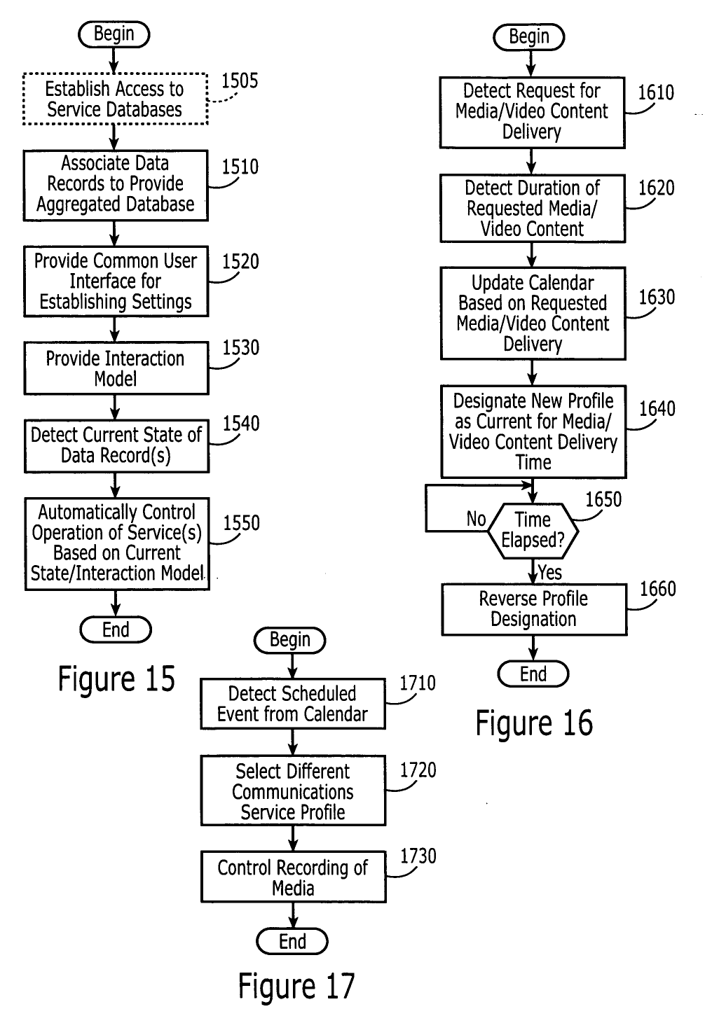

Operations for coordinated control of a plurality of different services for a user will now be described according to some embodiments of the present invention by reference to the flowchart illustration of FIG. 15. As described herein, the different services include a communications service of the user, a media service of the user, and a calendar of the user, although other services of a user may also be coordinated in some embodiments of the present invention. The communications service of the user may be a wire line phone service and/or a cellular phone service. Other communications services of the user may include text based communication services such as Instant Messaging, Short Message Service (SMS) and/or Multimedia Message Service (MMS ) text messaging services. The various services may be provided by a plurality of different service providers and/or in whole or in part be resident on a local computer processing device of a user.

As shown in the embodiments of FIG. 15, operations across the different services may start by establishing access to associated databases of the respective services, such as access to a profile database of the communications service, a media service database of the user and/or a calendar database of the user, which access may be through a common interface module (block 1505). Data records from each of the different services are associated to provide an aggregated database (block 1510). The data records from the communications service, such as a wire line phone or cellular phone service, may include settings for a plurality of features associated with the communications services. For example, the features may include Call Blocking, Call Filtering, Call Forwarding, Voice Mail and/or Email Notification. Operations to associate data records at block 1510 may include accessing the various databases to which access was obtained at block 1505.

A user interface is provided to a user for establishing settings of at least one of the data records in the aggregated database to control the different services (block 1520). An interaction model associated with the different services is provided (block 1530). Various aspects of the interaction model at block 1530 may be provided utilizing input obtained through the user interface provided at block 1520.

A current state of at least one of the data records in the aggregated database is detected, more particularly, of a data record in the database that is specified in the interaction model for use in coordinating control of different services (block 1540). Operation of one or more of the different services is then automatically controlled based on the detected current state from block 1540 and the interaction model provided at block 1530 (block 1550). For example, operations at block 1550 may involve automatically controlling operation of one of the communications services of the user, the media service of the user and/or the calendar of the user responsive to detecting the current state of at least one of the data records from another one of the services.

In some embodiments of the present invention, the data records from the communications service of the user include a plurality of user selectable profiles defining different settings for ones of the features and a designation of one of those profiles as the current settings of the communications service. In such embodiments, the media service may include a personal video recorder. Operations at block 1540 and 1550 may then include detecting playing of a video by the personal video recorder as a current state of the media service and operations of the communications service may be automatically controlled by designating a different one of the user selectable profiles as the current settings of the communications service based on the detected current state and the interaction model. For example, a Do Not Disturb (DND) profile may be selected as the current settings for the communications service to block phone calls and the like from disturbing the user while playing a video on the personal video recorder.

In other embodiments of the present invention, operations for detecting a current state at block 1540 include identifying one of the communications service profiles that is designated as the current settings of the communications service and operations at block 1550 include automatically controlling a recording schedule for the personal video recorder based on the identified one of the profiles and the interaction model. For example, a user may have a communications service profile designated “vacation.” Programming operations for the video recorder may be set up to record designated media content when the user is on vacation.

Thus, some embodiments of the present invention provide methods allowing incorporation of all the data that exists in separate instances in a profile, calendar, personal video recorder (PVR), and the like and allow them to be managed through a common interface and further, to allow them to interact with each other. For instance, if a user is watching a movie on their TV, their profile could optionally switch automatically to Do Not Disturb as discussed above. All non-urgent calls and messages could then be routed to voicemail or an in-box As also discussed above, if a user sets their profile to “vacation,” the personal video recorder may automatically record favorite TV shows in addition to changing outgoing message to the “vacation” setting for other services, such as the communications service. Furthermore, as will be further described with reference to FIG. 16, in some embodiments of the present invention, if a user purchases a Video on Demand, Pay Per View movie or the like media content, their calendar and profile may be updated to reflect the start time, duration and profile change associated with the purchased/ordered media content. Changes could be reflected immediately or in concurrence with the future delivery interval of the forthcoming movie, vacation, errand, or other event affecting user preferences across communications, calendar, and media services.

Operations for coordinated control of a plurality of different services for a user according to some embodiments of the present invention will now be further described with reference to the flowchart illustration of FIG. 16. As shown in FIG. 16, a request for delivery at a future time of a video (and/or audio) content by the media service is detected as a current state of a data record in the aggregated database (block 1610). The duration of the media/video content to be delivered at a future time may also be detected (block 1620).

A data record of the calendar of the user is automatically updated to indicate delivery of the media/video content at the future time in the calendar of the user and duration of the delivery of the video content (block 1630). Thus, information obtained from data records associated with a media service may be used to automatically control operation of the calendar of the user. In addition, a different one of a plurality of user selectable profiles of a communications service of the user may be designated as the current settings of the communications service, where the redesignation may occur at the future time associated with the delivery of the ordered media/video content (block 1640). The redesignation may be based on a time in the request for delivery at the future time of the content and on the interaction model associated with the different services. After the time scheduled for delivery of the media/video content is elapsed (block 1650), the designation of the current settings for the communications service may be reset to reverse the designation of a different one of the user selectable profiles as the current setting (block 1660). For example, the profile originally set by the user may be a default profile allowing Call Ringing and Call Forwarding and a Do Not Disturb profile may be selected during delivery of the scheduled media/video content. Calls and Call Forwarding may automatically be allowed again once the scheduled time for delivery of the media/video content has passed.

Operations for coordinated control of a plurality of different services for a user according to further embodiments of the present invention will now be described with reference to the flowchart illustration of FIG. 17. For the embodiments illustrated in FIG. 17, the data records from a communications service include a plurality of user selectable profiles defining different settings for ones of the features of the communications service and a designation of one of those profiles as the current settings of the communications service. As shown in the embodiments of FIG. 17, a current state of a first service of a user is detected by detecting a scheduled event from the calendar of the user (block 1710). Operation of the communications service is automatically controlled by designating a different one of the user selectable profiles as the current settings of the communications service (block 1720). A recording schedule for a personal video recorder included in the media service is automatically controlled based on the identified one of the profiles in the interaction model (block 1730).

For example, a meeting could appear on a user's schedule (calendar) that could be during the same time as scheduled broadcast of a favorite television show of the user. Operations at block 1720 may then include selecting a Do Not Disturb profile to prevent phone calls or voicemails from intruding on the meeting during the scheduled meeting identified in the calendar of the user as detected at block 1710. In addition or instead of controlling selection of an alternative profile for the communications service, the personal video recorder of the user may be controlled to allow taping of the favorite television show by the personal video recorder at block 1730. As such, the interaction model for the operations at block 1730 to initiate recording of the show and changing the profile may include an identification of preferred shows of the user as well as an identification of the conditions which will trigger automatic recording of such shows. For example, the user could designate particular types of scheduled calendar events that would cause recording of different ones of the favorite shows and/or could generate an identification of particular ones of the user selectable profiles of the communications service, such as the “vacation” profile, as automatically causing recording of one or more of the preferred shows specified by the user.

It will be understood that the aggregated database as discussed above may be a separate database that includes data records gathered from databases maintained by the various services of the user and provides a unified database with the associated data records. However, it will also be understood that, in some embodiments of the present invention, the aggregated database does not require creation of a separate data store with all of the records in a single unified database and the aggregated database may be provided by an interface allowing unified access with queries to respective ones of the different services' databases as needed to carry out operations in accordance with various embodiments of the present invention as described herein. It will also be understood that automatically controlling operations as described herein may include communicating instructions to one or more devices associated with the different services using an Internet Protocol (IP) format. For example, the devices may include a voice over Internet protocol (VoIP) telephone, a personal video recorder (PVR), or the like. These devices may further be accessed through a home media hub or the like, which may allow addressing and control of PVR or other media or telephone devices that are not themselves directly addressable using the Internet protocol addressing scheme.

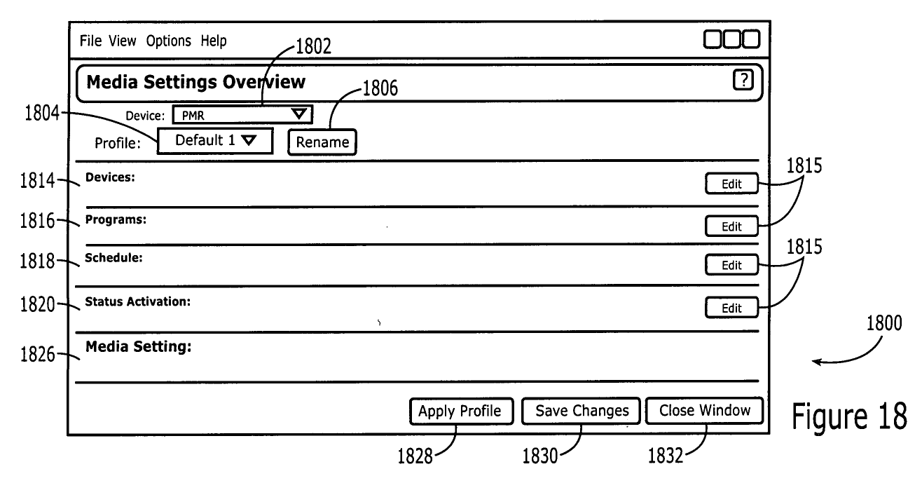

A user display 1800 that may be generated for a user responsive to selection of the media settings field 609 of FIG. 6 as will now be described with reference to the schematic illustration of FIG. 18. As shown in the embodiments FIG. 18, the user display 1800 includes a device identification field 1802, shown as selecting a personal medial recorder (PMR) of a user in FIG. 18. A profile identification field 1804 is shown for selecting a profile associated with a device identified in the device identification field 1802. A rename field 1806 is also shown for renaming a currently established profile.

The user display 1800 further includes a plurality of user option fields 1814 through 1820 and a media setting summary field 1826. The media setting summary field 1826 generally corresponds to the call management summary field 726 of FIG. 7.

For the embodiments shown in FIG. 18, the user option fields include a devices field 1814, a programs field 1816, a schedule field 1818 and a status activation field 1820, each of which has an associated edit field 1815 that may be selected to bring up additional associated user option information. For example, the devices 1814 may include underlying user options related to different communications service and/or media devices for which a user may designate association information for use in generating an interaction model for the user. Summarily, the programs field 1816 may have underlying user option information for designation of entertainment programs or the like that will be incorporated in the interaction model for the user. The schedule field 1818 may have underlying information related to scheduling aspects of programs and/or activities of the user and/or may provide a user interface point to a calendar of the user so as to allow access to the user's calendar for a user through the user display 1800. The status activation field 1820 may include underlying information related to user manual entry of information regarding the current status of one or more devices associated with the user or the like. While no media setting summary information is provided in the media setting summary field 1826 shown in FIG. 18, upon user designation and input of information through the user option fields 1814 through 1820 or by selection of a device or profile in the fields 1802, 1804, the interaction module may generate a plain language textual summary of the effect of the selected media settings in the media setting summary field 1826.

Also shown in the embodiments of FIG. 18 are an Apply Profile field 1828, a Save Changes field 1830 and a Close Window field 1832. The fields 1828, 1830 and 1832 operate substantially the same as the corresponding fields 728, 730 and 732 of FIG. 7.

It will be understood that at least a portion of the communications described herein can be provided according to Session Initiation Protocol (SEP), which is described in more detail in, for example, “Internet Communications Using SIP,” by Henry Sinnreich, ISBN: 0-471-41399-2. Internet Protocol communications are generally described in, for example, “TCP/IP Protocol Suite,” by Behrouz A Forouzan, ISBN: 0-07-119962-4. Moreover, techniques for the creation and operation of virtual communities, is described in, for example, “Design for Community: The Art of Connecting Real People in Virtual Places,” by Derek M. Powazek, ISBN: 0-7357-1075-9. The content these references is incorporated herein by reference.

The communications used for messages may be provided using an Internet Protocol (IP) Multimedia Subsystem (IMS). IMS can utilize a packet switched domain (such as the Internet) to transport multimedia signaling and bearer traffic. The message forwarding may be provided, for example, via a Universal Mobile Telecommunication System (UMTS) to access multimedia services of IMS. IP Multimedia Systems are discussed in each of the following: (1) 3GPP TS 22.228 entitled “Service Requirements for the IP Multimedia Core Network Subsystems”; (2) 3GPP TS 23.228 entitled “IP Multimedia Subsystems”; and (3) 3GPP TR 22.941 entitled “IP Based Multimedia Services Framework.” The subject matter of each of these references is hereby incorporated by reference.

It will be understood that messages can be provided via a TCP/IP Session Initiation Protocol (SIP) message, a SS7 (Signaling System 7) message, a common channel SS7 message, an in-band signaling message, and/or a Short Message Service (SMS) message, an Enhanced Message Service (EMS) message, a Multimedia Message Service (MMS) message, and/or SmartmessagingTM message. As is known to those skilled in the art, SMS and EMS messages can be transmitted on digital networks, such as GSM networks, allowing relatively small text messages (for example, 160 characters in size) to be sent and received via a network operator's message center to the user device, or via the Internet, using a so-called SMS (or EMS) “gateway.”

In the drawings and specification, there have been disclosed embodiments of the invention and, although specific terms are employed, they are used in a generic and descriptive sense only and not for purposes of limitation, the scope of the invention being set forth in the following claims.

What is claimed:

1. A computer implemented method of coordinated control of a plurality of different services for a user, comprising:
associating data records from each of the different services to provide an aggregated database, wherein the different services include a communications service of the user, a media service of the user and a calendar of the user;
providing a user interface to a user for establishing settings of at least one of the data records in the aggregated database to control the different services;
providing an interaction model associated with the different services;
detecting a current state of at least one of the data records in the database that is specified in the interaction model; and
automatically controlling operation of at least one of the different services based on the detected current state and the interaction model.

2. The method of claim 1, wherein automatically controlling comprises automatically controlling operation of one of the communications service of the user, the media service of the user and the calendar of the user responsive to detecting the current state of at least one of the data records from another of the communications service of the user, the media service of the user and the calendar of the user.

3. The method of claim 2, wherein the communications service comprises wireline phone service and/or cellular phone service and wherein the data records from the communications service include settings for a plurality of features associated with the communications services.

4. The method of claim 3, wherein the features include call blocking, call filtering, call forwarding, voicemail and/or email notification.

5. The method of claim 4, wherein associating data records comprises accessing a profile database of the communications service, a media service database of the user and a calendar database of the user through a common interface module.

6. The method of claim 4, wherein the data records from the communications service comprise a plurality of user selectable profiles defining different settings for ones of the features and a designation of one of the profiles as the current settings of the communications service and wherein the media service includes a personal video recorder and wherein detecting a current state comprises detecting playing of a video by the personal video recorder as a current state of the media service and wherein automatically controlling comprises automatically controlling operation of the communications service by designating a different one of the user selectable profiles as the current settings of the communications service based on the detected current state and the interaction model.

7. The method of claim 4, wherein the data records from the communications service comprise a plurality of user selectable profiles defining different settings for ones of the features and a designation of one of the profiles as the current settings of the communications service and wherein the media service includes a personal video recorder and wherein detecting a current state comprises identifying the one of the profiles that is designated as the current settings of the communication service and wherein automatically controlling comprises automatically controlling a recording schedule for the personal video recorder based on the identified one of the profiles and the interaction model.

8. The method of claim 4, wherein detecting a current state comprises detecting a request for delivery at a future time of a video content by the media service and wherein automatically controlling comprises automatically updating a data record of the calendar to indicate delivery of the video content at the future time in the calendar of the user.

9. The method of claim 8, wherein automatically controlling further comprises automatically controlling operation of the communications service by designating a different one of the user selectable profiles as the current settings of the communications service at the future time based on the request for delivery at the future time of the video content and the interaction model.

10. The method of claim 9, wherein designating a different one of the user selectable profiles as the current settings of the communications service is carried out at the future time.

11. The method of claim 9, wherein detecting a request for delivery at a future time includes detecting a duration of the video content and wherein designating a different one of the user selectable profiles as the current settings comprises designating a different one of the user selectable profiles as the current settings of the communications service starting at the future time and for the detected duration of the video content and then resetting the designation of the current settings to reverse the designation of the different one of the user selectable profiles as the current settings.

12. The method of claim 8, wherein detecting a request for delivery at a future time includes detecting a duration of the video content and wherein automatically updating a data record of the calendar to indicate delivery of the video content at the future time in the calendar of the user includes automatically updating a data record of the calendar to indicate the duration of the delivery of the video content at the future time in the calendar of the user.

13. The method of claim 4, wherein the data records from the communications service comprise a plurality of user selectable profiles defining different settings for ones of the features and a designation of one of the profiles as the current settings of the communications service and wherein detecting a current state comprises detecting a scheduled event from the calendar of the user and wherein automatically controlling further comprises automatically controlling operation of the communications service by designating a different one of the user selectable profiles as the current settings of the communications service and/or automatically controlling a recording schedule for a personal video recorder included in the media service based on the identified one of the profiles and the interaction model.

14. The method of claim 4 wherein automatically controlling operation comprises communicating instructions to at least one device associated with the at least one of the different services using an Internet Protocol (IP) format.

15. The method of claim 14, wherein the at least one device comprises a Voice over Internet Protocol (VoIP) telephone, a personal video recorder (PVR) and/or a home media hub.

16. A computer program product for coordinated control of a plurality of different services for a user, the computer program product comprising computer program code embodied in a computer readable medium, the computer program code comprising program code configured to carry out the method of claim 1.

17. A computer system configured to carry out the method of claim 1.

18. A computer program product for coordinated control of a plurality of different services for a user, the computer program product comprising computer program code embodied in a computer readable medium, the computer program code comprising program code configured to carry out the method of claim 4.

19. A computer system configured to carry out the method of claim 4.

20. A computer system for coordinated control of a plurality of different services for a user, comprising:
an aggregated database that associates data records from each of the different services, wherein the different services include a communications service of the user, a media service of the user and a calendar of the user;
an interaction model associated with the different, the interaction model defining actions to control operations of ones of the different services based on a current state of the different services; and
a service management module configured to provide a user interface to a user for establishing settings of at least one of the data records in the aggregated database to control the different services, detect a current state of at least one of the data records in the database that is specified in the interaction model and to automatically control operation of at least one of the different services based on the detected current state and the interaction model.
